(19) United States
(12) Patent Application Publication
(10) Pub. No.: US 2008/0025455 A1
(43) Pub. Date: Jan. 31, 2008

(54) REACTOR FEEDWATER SYSTEM

(75) Inventors: Kazuo HISAJIMA, Kanagawa-Ken (JP); Shigeki YOKOHAMA, Kanagawa-Ken (JP); Takuya MIYAGAWA, Tokyo (JP); Seijiro SUZUKI, Kanagawa-Ken (JP); Koichi KONDO, Kanagawa-Ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/778,888

(22) Filed: Jul. 17, 2007

(30) Foreign Application Priority Data
Jul. 26, 2006 (JP) 2006-202940

(51) Int. Cl. G21C 9/00

(52) U.S. Cl. 376/282

(57) ABSTRACT

A reactor feedwater system of a boiling water reactor includes: a reactor feedwater pump and a high pressure feedwater heater, that are arranged at an outside of a reactor containment vessel containing a reactor pressure vessel of a boiling water reactor, for pressurizing and heating a coolant; a main feedwater pipe for supplying the coolant, that are pressurized and heated by the reactor feedwater pump and the high pressure feedwater heater, to a side of the reactor containment vessel; and a plurality of branch pipes, that are connected to the main feedwater pipe, for pouring the coolant into the reactor pressure vessel. The main feedwater pipe is provided to the outside of the reactor containment vessel, and branching positions at which the branch pipes are branched from the main feedwater pipe are set to the outside of the reactor containment vessel, so that only the branch pipes penetrate through the reactor containment vessel and are connected to the reactor pressure vessel.

### BACKGROUND OF THE INVENTION

1. Field of the Invention

The present invention relates to a reactor feed water system for cooling a reactor core provided in a boiling water reactor, particularly relates to a reactor feedwater system improved in structures of a main feedwater piping for supplying a coolant and a plurality of branch pipes connected to the main feedwater piping.

2. Related Art

In general, a conventional nuclear power plant comprising a boiling water reactor (BWR) has a structure in which turbine blades of a steam turbine are rotated by steam generated in the reactor to thereby generate electric power. The steam is then cooled and condensed by a condenser to convert into condensate. The condensate is pressurized by a condensate pump to increase a pressure thereof. Further, the pressurized condensate is heated and supplied to a reactor feedwater system.

The reactor feedwater system is configured by comprising: a reactor feedwater pump and a high pressure feedwater heater, that are arranged at an outside of a reactor containment vessel containing a reactor pressure vessel of a BWR, for pressurizing and heating a coolant; a main feedwater pipe for supplying the coolant, which is pressurized and heated by the reactor feedwater pump and the high pressure feedwater heater, to a side of the reactor containment vessel; and a plurality of branch pipes, that are connected to the main feedwater pipe, for pouring the coolant into the reactor pressure vessel.

In the above conventional reactor feedwater system, in general, each of two lines of the main feedwater pipes is branched into a plurality of branch pipes respectively within the reactor containment vessel, so that the branched pipes are connected to the reactor pressure vessel.

As the reactor feedwater system, there is a type in which each of three lines of the main feedwater pipes is branched into a plurality of branch pipes, as observed in the BWR having an electric power of about 1,100 MW or more. Further, there is also another type in which each of two lines of the main feedwater pipes is branched into a plurality of branch pipes, as observed in the BWR having an electric power of less than 1,100 MW.

The above features are disclosed in, for example, a patent document 1 (Japanese Unexamined Patent Application Publication No. 5-323085) and a non-patent document 1 (“Outline of Light Water Reactor Power Station” published by Nuclear Power Safety Research Association on October, 1992; p 41, FIGS. 2, 4.1).

With reference to FIGS. 4, 5 and 6, there will be explained a configuration of the conventional reactor feedwater system in which conventional technique is applied to a middle-scaled advanced boiling water reactor (ABWR) having the electric power of less than about 1,100 MW. FIG. 4 is an overall system diagram showing configurations of a reactor feedwater system 100 and relating reactor systems. FIG. 5 is an enlarged plan view showing a structure of nearby portions at inside and outside of the reactor containment vessel among the reactor feedwater system 100 shown in FIG. 4. FIG. 6 is a diagram showing a network of an emergency core cooling system.

As shown in FIG. 4, a reactor pressure vessel 102 is installed at a central portion of the reactor containment vessel 101. A suppression chamber 103 is formed in a lower circumferential portion of the reactor containment vessel 101. The steam generated at the reactor pressure vessel 102 is supplied to a turbine system, not shown, to thereby generate the electric power. Thereafter, the steam is cooled and condensed by a condenser 105 of a condensate system 104 to be converted into condensate. The condensate is pressurized by a condensate pump 107 provided to condenser system pipe 106 to thereby increase a pressure thereof. Further, the pressurized condensate is heated by a low-pressure feedwater heater 108, and supplied to a reactor feedwater system 100.

The reactor feedwater system 100 comprises a reactor feedwater pump (RFP) 110 and a high-pressure feedwater heater 111 arranged in a feedwater pipe 109. The condensate is further pressurized by the reactor feedwater pump (RFP) 110 so as to increase a pressure thereof. The pressurized condensate is further heated by the high-pressure feedwater heater 111 and supplied as a coolant to a side of the reactor pressure vessel 102.

Two lines of main feedwater pipes 112a, 112b are connected to the feedwater pipe 109, and these main feedwater pipes 112a, 112b pass and penetrate through the reactor containment vessel 101 and are led to the side of the reactor pressure vessel 102. In the reactor containment vessel 101, there are provided branch pipes 113a, 113b, 114a, 114b that are branched from each of the main feedwater pipes 112a, 112b. These branch pipes 113a, 113b, 114a, 114b are finally connected into the reactor pressure vessel 102.

In this connection, the boiling water reactor is provided with an emergency core cooling system (ECCS) for pouring the coolant supplied from the suppression chamber 103 into a reactor core and flooding the reactor core. That is, the emergency core cooling system (ECCS) comprises a reactor core isolation cooling system (RCIC) 115, a high pressure core flooder system (HPCF) 116, and a residual heat removal system (RHR) 117.

The reactor core isolation cooling system (RCIC) 115 comprises a reactor core isolation cooling system pump 115a, and a reactor core isolation cooling system injection pipe 115b. This reactor core isolation cooling system injection pipe 115b is connected to one of the main feedwater pipe 112a at the outside of the reactor containment vessel 101 (connection point A).

The high pressure core flooder system (HPCF) 116 is configured so as to have independent two systems, and each of the systems comprises high pressure core flooder pumps 120a, 120b and high pressure core flooder injection pipes 121a, 121b. These high pressure core flooder injection pipes 121a, 121b are directly connected to the reactor pressure vessel 102.

The residual heat removal system (RHR) 117 is configured so as to include independent three systems, and each of the systems comprises residual heat removal system pumps 118a, 118b, 118c, residual heat removal system heat exchangers 122a, 122b, 122c, and residual heat removal system injection pipes 119a, 119b, 119c. Among the residual heat removal system injection pipes, one line of the residual heat removal system injection pipe 119b is connected to another main feedwater pipe 112b at the outside (connection point B) of the reactor containment vessel 101. The other two lines of the injection pipes 119a and 119c are directly connected to the reactor pressure vessel 102.

Next, with reference to FIG. 4 and FIG. 5, branching structures, connection points (connecting positions) and valve structures of the main feedwater pipes 112a, 112b and the branch pipes 113a, 113b, 114a, 114b will be explained hereunder.

As shown in FIG. 5, two lines of the main feedwater pipes 112a, 112b are arranged to be parallel with each other, and pass through the reactor containment vessel 101 from outside to inside thereof. Each of the main feedwater pipes 112a, 112b extends in a direction opposing to each other in a circular-arc shape so as to respectively surround an outer circumferential portion ranging about half around of the reactor pressure vessel 102.

A first branch pipe 113a is branched from one main feedwater pipe 112a at a starting position (upstream position) where a curved portion in a circular-arc shape of the main feedwater pipes 112a starts. On the other hand, a second branch pipe 113b is branched from the one main feedwater pipes 112a at an ending position (downstream position) where a curved portion in a circular-arc shape of the main feedwater pipe 112a is terminated.

A third branch pipe 114a is branched from another main feedwater pipe 112b at a starting position (upstream position) where a curved portion in a circular-arc shape of the main feedwater pipe 112b starts. On the other hand, a fourth branch pipe 114b is branched from another main feedwater pipe 112b at an ending position (downstream position) where a curved portion in a circular-arc shape of the main feedwater pipe 112b is terminated.

In addition, as also shown in FIG. 4, a line of the reactor core isolation cooling system injection pipe 115b is connected to one main feedwater pipe 112a at an outside (connection point A) of the reactor containment vessel 101, while a line of the residual heat removal system injection pipe 119b is connected to another main feedwater pipe 112b at an outside (connection point B) of the reactor containment vessel 101.

Further, as shown in FIG. 5, remaining two lines of the residual heat removal system injection pipes 119a, 119c are independently connected to the reactor pressure vessel 102, respectively. Connecting positions, where these two lines of the residual heat removal system injection pipes 119a, 119c are connected to the reactor pressure vessel 102, are set to about an intermediate portion between the first branch pipe 113a and the second branch pipe 113b, and about an intermediate portion between the third branch pipe 114a and the fourth branch pipe 114b, respectively.

Furthermore, as shown in FIGS. 4 and 5, each of the main feedwater pipes 112a, 112b is provided with various valves at inside portion and outside portion of the reactor containment vessel 101. That is, each of the main feedwater pipes 112a, 112b is subsequently provided with stop valves 130a, 130b for backup use, check valves 132a, 132b, and reactor containment vessel isolation valves 133a, 133b in this order from an upstream side to a downstream side at the outside portion of the reactor containment vessel 101.

Furthermore, each of the main feedwater pipes 112a, 112b is provided with reactor containment vessel isolation valves 134a, 134b, and stop valves 135a, 135b for maintenance check in this order from an upstream side to a downstream side at the inside portion of the reactor containment vessel 101.

Among these valves, the reactor containment vessel isolation valves 133a, 133b, 134a, 134b are arranged into the main feedwater pipes 112a, 112b at inside and outside portions of the reactor containment vessel 101 so that the reactor containment vessel isolation valves 133a, 133b, 134a, 134b are confronted to each other at border portions where the main feedwater pipes 112a, 112b penetrate through the reactor containment vessel 101.

Further, in the outside of the reactor containment vessel 101, a reactor core isolation cooling system injection pipe 115b is connected to the main feedwater pipe 112a, while a residual heat removal system injection pipe 119b is connected to another main feedwater pipe 112b. The reactor core isolation cooling system injection pipe 115b and the residual heat removal system injection pipe 119b are provided with stop valves 136a, 136b for backup use and check valves 137a, 137b in this order from an upstream side to a downstream side.

Furthermore, the other two lines of the residual heat removal system injection pipes 119a, 119c are independently connected to the reactor pressure vessel 102. At the outside of the reactor containment vessel 101, the residual heat removal system injection pipes 119a, 119c are provided with stop valves 138a, 138b for backup use and reactor containment vessel isolation valves 139a, 139b in this order from an upstream side to a downstream side. On the other hand, at the inside of the reactor containment vessel 101, the residual heat removal system injection pipes 119a, 119c are provided with reactor containment vessel isolation valves 140a, 140b and stop valves 141a, 141b for maintenance check in this order from an upstream side to a downstream side.

In this regard, as shown in FIG. 6 in which a network of an emergency reactor core cooling system of the ABWR is indicated, the emergency reactor core cooling system is a system for pouring pool water, which is stored in a suppression chamber 103 formed at a lower portion of the reactor containment vessel 101, into the reactor pressure vessel 102 when loss of coolant accident (LOCA) or the like occurs, so that a temperature of fuel cladding tubes constituting a fuel assembly is suppressed to be lower than a permissive value, thereby maintaining a soundness of the fuel assembly.

This emergency reactor core cooling system consists of independent three divisions, and each of a high pressure flooding system (reactor core isolation cooling system or a high pressure core flooder system) and a low pressure flooder system (residual heat removal system) is provided to the respective three divisions.

In such a conventional reactor feedwater system as described above, the main feedwater pipes are branched at an inside portion of the reactor containment vessel. Therefore, in order to sufficiently cope with a severe situation such as the loss of coolant accident (LOCA) or the like, it is necessary to assume a complete rapture (fracture) of at least one line of the main feedwater pipe.

At this time of the accident, a pressure rise in the reactor containment vessel becomes to be most severe. Therefore, the reactor containment vessel is required to secure a sufficient free space volume which can effectively cope with the severe situation.

Therefore, even if the reactor containment vessel can afford to spare some space in view of arrangement of various equipments and piping or the like, there had been posed a problem such that the reactor containment vessel should be further downscaled for the purpose of effectively improving an economical efficiency.

### SUMMARY OF THE INVENTION

The present invention was conceived in consideration of the above circumstances, and an object of the present invention is to provide a reactor feedwater system capable of providing a boiling water reactor of which the reactor containment vessel can be significantly downscaled without impairing any safety of the reactor.

The above and other objects can be achieved according to the present invention by providing a reactor feedwater system of a boiling water reactor comprising:

a reactor feedwater pump and a high pressure feedwater heater, that are arranged at an outside of a reactor containment vessel containing a reactor pressure vessel of a boiling water reactor, for pressurizing and heating a coolant;

a main feedwater pipe for supplying the coolant, that are pressurized and heated by the reactor feedwater pump and the high pressure feedwater heater, to a side of the reactor containment vessel; and

a plurality of branch pipes, that are connected to the main feedwater pipe, for pouring the coolant into the reactor pressure vessel,

wherein the main feedwater pipe is provided to the outside of the reactor containment vessel, and branching positions at which the branch pipes are branched from the main feedwater pipe are set to the outside of the reactor containment vessel, so that only the branch pipes penetrate through the reactor containment vessel and are connected to the reactor pressure vessel.

In a preferred embodiment of the above aspect, it may be desired that each of the branch pipes is provided with a reactor containment vessel isolation valve. The containment vessel isolation valve may be provided to both inner and outer positions of the reactor containment vessel in a paired manner, and an injection pipe of either a reactor core isolation cooling system or a residual heat removal system of an emergency core cooling system is connected to a portion between the paired containment vessel isolation valves.

The emergency core cooling system may include one series of the reactor core isolation cooling system, and independent three series of the residual heat removal systems, and the injection pipes of these reactor core isolation cooling system and independent three series of the residual heat removal systems are connected to the branch pipes, respectively.

It may be also desired that the respective branch pipes are branched from the main feedwater pipe at a plurality of branching positions, a flow restriction mechanism is provided to a halfway of a branch pipe which is located and branched at a most upstream side in the coolant supplying direction, and a diameter of the main feedwater pipe, which is located at downstream side from a branching position of the branch pipe, is set to be smaller than that of a main feedwater pipe which is located at upstream side from the branching position.

The flow restriction mechanism is composed of a restriction orifice or flow nozzle.

In the reactor feedwater system according to the present invention, the reactor feedwater system is configured to have a structure in which the main feedwater pipe is provided to outside of the reactor containment vessel, and branching positions, at which the branch pipes are branched from the main feedwater pipe, are set to outside of the reactor containment vessel, and only the branch pipes are penetrated through the reactor containment vessel and connected to the reactor pressure vessel.

According to the above structure, there is no need to arrange the main feedwater pipe and any injection pipe for the residual heat removal system in the reactor containment vessel. In addition, a free space volume required for the reactor containment vessel at a time of the loss of coolant accident can be effectively reduced, so that the reactor containment vessel can be remarkably downscaled.

Further, the branch pipe has a pipe diameter larger than that of an injection pipe in the residual heat removal system, so that a fluid resistance of the branch pipe can be lowered, thus enabling the residual heat removal system pump to decrease a required pump head (load lifting height) thereof. According to this structure, a required driving power of the residual heat removal system pump can be also reduced. Therefore, there can be also reduced a capacity of an emergency power source (backup power source) for supplying the power to the residual heat removal system pump at the time of the loss of coolant accident or the like.

The nature and further characteristic features of the present invention will be made clearer from the following descriptions made with reference to the accompanying drawings.

### BRIEF DESCRIPTION OF THE DRAWINGS

In the accompanying drawings:

FIG. 1 is a schematic view showing an overall configuration of a reactor feedwater system according to an embodiment of the present invention and systems relating thereto;

FIG. 2 is an illustration of a schematic plan view showing a structure of a portion close to inside and outside of the reactor containment vessel, the view being a partial configuration of the reactor feedwater system according to the embodiment of the present invention;

FIG. 3 is an illustration of a schematic plan view showing another structure of a portion close to inside and outside of the reactor containment vessel, the view being a partial configuration of the reactor feedwater system according to another embodiment of the present invention;

FIG. 4 is a schematic view showing an overall configuration of a conventional reactor feedwater system and relating systems;

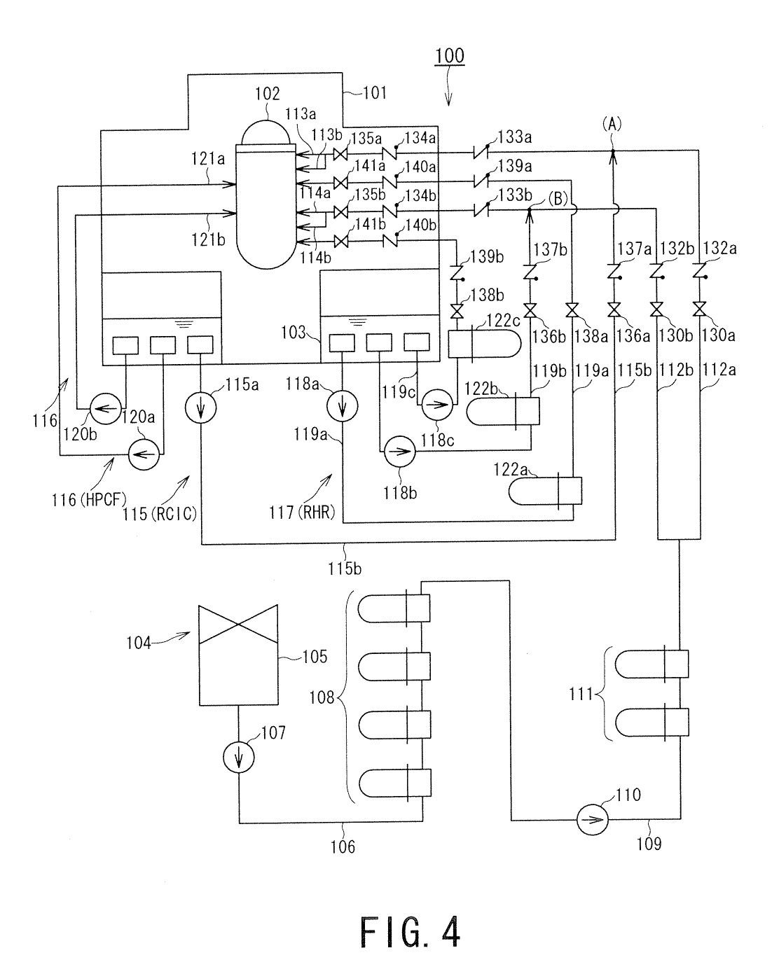

FIG. 5 is a partially enlarged plan view showing structure of nearby portions at inside and outside of the reactor containment vessel, which is also a partial configuration of the conventional reactor feedwater system; and

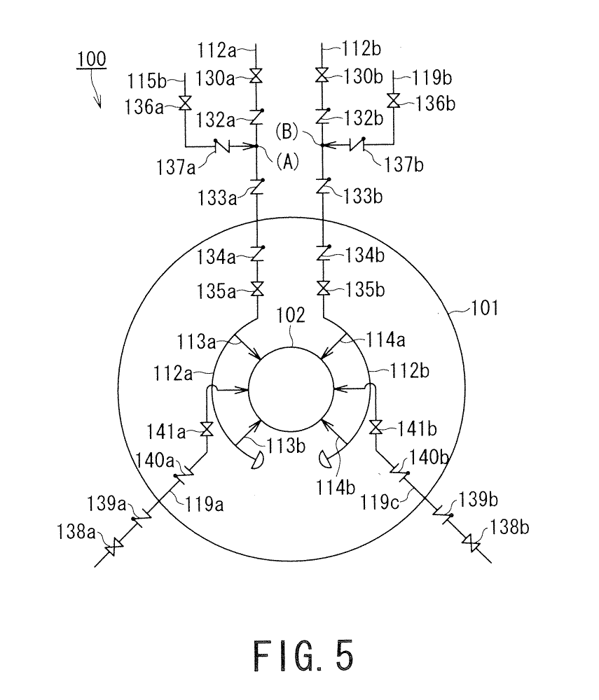

FIG. 6 is a diagram showing a network of an emergency core cooling system of an advanced boiling water reactor.

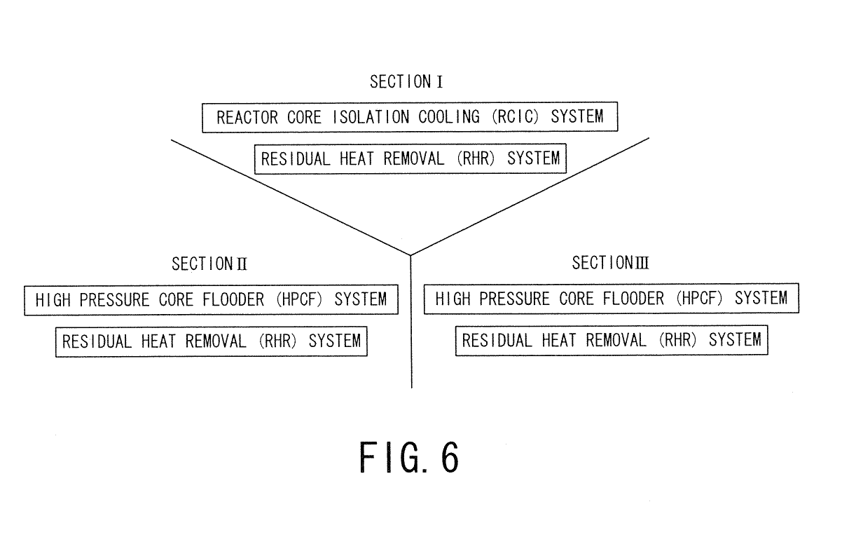

### DESCRIPTION OF THE PREFERRED EMBODIMENTS

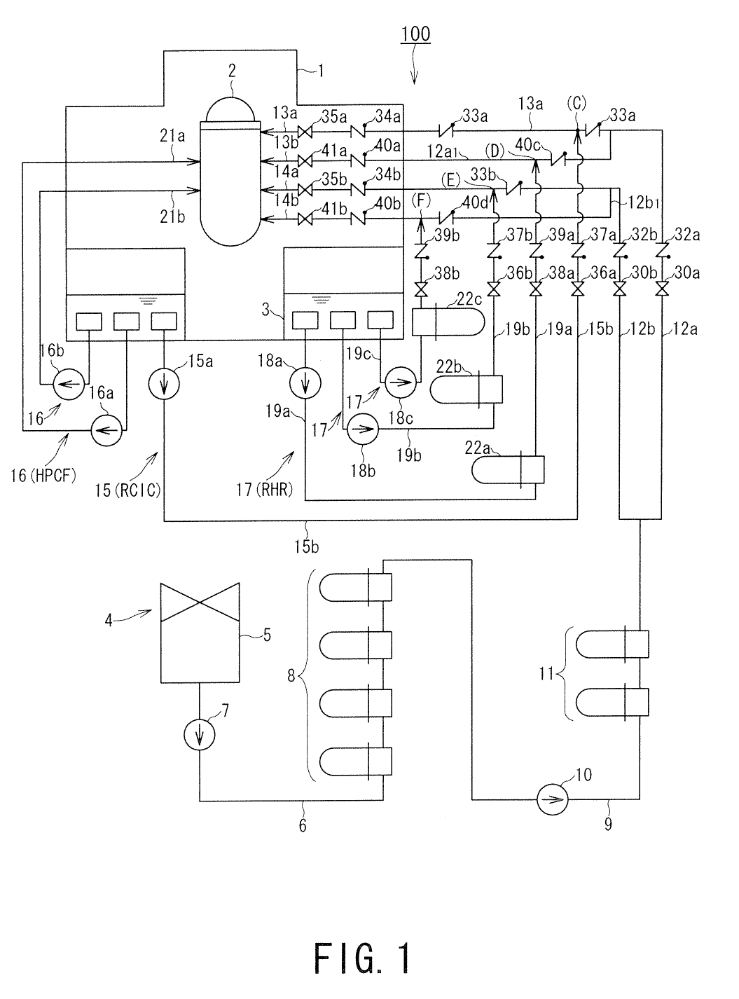

An embodiment of reactor feedwater system according to the present invention will be described hereunder with reference to the accompanying drawings of FIGS. 1 to 3.

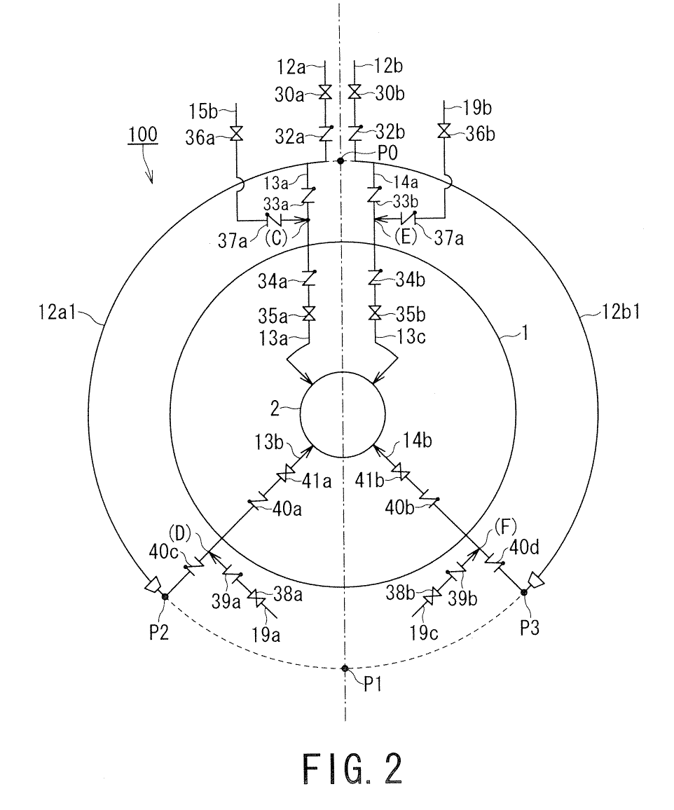

First, FIGS. 1 and 2 represent a reactor feedwater system 100 according to an embodiment of the present invention and relating systems. FIG. 1 is a view showing an overall configuration of a reactor feedwater system 100, and FIG. 2 is a plan view showing a structure of a portion close to inside and outside of the reactor containment vessel among the reactor feedwater system 100 shown in FIG. 1.

As shown in FIGS. 1 and 2, in the present embodiment, the reactor containment vessel 1 has a vertically extended cylindrical shape, and a cylindrical reactor pressure vessel 2 is installed at a center of the reactor containment vessel 1 so as to be coaxial with the reactor containment vessel 1.

At a lower circumferential portion of the reactor pressure vessel 2 in the reactor containment vessel 1, there is formed a suppression chamber 3. Steam generated at the reactor pressure vessel 2 is supplied to a turbine system and used for generating an electric power. Then, the used steam is cooled and condensed by a condenser 5 of a condensate system 4 to be thereby converted into a condensate. This condensate is then pressurized by a condensate pump 7 provided to a condensate system pipe 6 and further heated by a low pressure feedwater heater 8 so as to be supplied to the reactor feedwater system 100.

The reactor feedwater system 100 comprises a feedwater pipe 9 connected to a condensate system pipe 6. The feedwater pipe 9 includes a reactor feedwater pump 10, and a high-pressure feedwater heater 11 so that the condensate is further pressurized and heated. The pressurized and heated condensate is then fed as the coolant to a side of the reactor pressure vessel 2.

In the present embodiment having a structure described above, two lines of main feedwater pipes 12a, 12b are connected to the feedwater pipe 9, and these main feedwater pipes 12a, 12b are arranged only at a portion at an outside of the reactor containment vessel 1. That is, the two lines of main feedwater pipes 12a, 12b are extended to a portion close to an outer circumferential surface of the reactor containment vessel 1 so as to be arranged in parallel with each other.

However, the main feedwater pipes 12a, 12b are not penetrated into an inside of the reactor containment vessel 1, but extended from the portion close to the outer peripheral surface of the reactor containment vessel 1 so that the main feedwater pipes 12a, 12b go around along the outer circumferential surface of the reactor containment vessel 1 thereby to form a curved shape.

For example, as shown in FIG. 2, a curved end portion of one main feedwater pipe 12a extends along an outer circumference of the reactor containment vessel 1 to an angle position P2 which is deviated from an angle position P1 at an angle of about 45 degrees, the angle position P1 being symmetric with an angle position P0 at which a straight portion in the upstream side of the main feedwater pipe 12a exists.

Similarly, a curved end portion of the other main feedwater pipe 12b extends in a direction opposite to that of the main feedwater pipe 12a along the outer circumference of the reactor containment vessel 1 to an angle position P3 which is deviated from an angle position P1 at an angle of about 45 degrees, the angle position P1 being symmetric with an angle position P0 at which the straight portion in the upstream side of the main feedwater pipe 12b exists.

That is, the two lines of the main feedwater pipes 12a, 12b extend along the outer circumference of the reactor containment vessel 1 in directions opposite to each other and go about half around of the reactor containment vessel 1, so that the main feedwater pipes 12a, 12b, each having a circular-arc shape, surround the reactor containment vessel 1. In other words, each of the two lines of the main feedwater pipes 12a, 12b is formed at an outer circumference of a fan-shaped territory making an angle of 135 degrees.

As described above, the main feedwater pipes 12a, 12b are arranged along the outer circumference surface of the reactor containment vessel 1 so as to surround the reactor containment vessel 1 with leaving a predetermined spacing distance from an outer surface of the reactor containment vessel 1.

Under this structure, the branching positions, at which the branch pipes 13a, 13b, 14a, 14b are connected to each of the main feedwater pipes 12a, 12b, are set to the outside of the reactor containment vessel 1. That is, among the two lines of the main feedwater pipes 12a, 12b extending in parallel arrangement so as to be perpendicular to the outer circumferential surface of the reactor containment vessel 1, the first branch pipe 13a is branched at a branching position set on one main feedwater pipe 12a. The branching position is set to a curved portion apart with a predetermined short distance from a point at which a front edge of the main feedwater pipe 12a starts to go around along the outer circumference surface of the reactor containment vessel 1.

The first branch pipe 13a linearly extends in a straight direction which is slightly deviated from a linearly extending direction of the one main feedwater pipe 12a. The first branch pipe 13a then penetrates through a circumferential wall of the reactor containment vessel 1, and further extends within the reactor containment vessel 1.

The first branch pipe 13a is slightly curved at a portion close to the reactor pressure vessel 2 so as to be along a circumferential wall of the reactor pressure vessel 2. Thereafter, the first branch pipe 13a changes its extending direction at angle of about 45 degrees when a piping layout is viewed from an upper position of a plane surface, whereby the first branch pipe 13a directs to a center portion of the reactor pressure vessel 2. As a result, the first branch pipe 13a is then straightly arranged along a normal line direction, and finally connected to the reactor pressure vessel 2.

Further, a second branch pipe 13b is branched and connected to a portion close to a top end of the curved one main feedwater pipe 12a which goes around an outer circumference of the reactor containment vessel 1. The second branch pipe 13b extends in a direction perpendicular to that of the first branch pipe 13a, and is directed to a center portion of the reactor pressure vessel 2. As a result, the second branch pipe 13b is straightly arranged along a normal line direction, and finally connected to the reactor pressure vessel 2.

Furthermore, the other main feedwater pipe 12b is also configured by substantially the same manner as in the one main feedwater pipe 12a. That is, a third branch pipe 14a is branched at a branching position set on the other main feedwater pipe 12b. The branching position is set to a curved portion apart with a predetermined short distance from a point at which a front edge of the main feedwater pipe 12b starts to go around along the outer circumferential surface of the reactor containment vessel 1.

The third branch pipe 14a linearly extends in a straight direction which is slightly deviated from a linearly extending direction of the one main feedwater pipe 12a so as to oppose to each other. The third branch pipe 14a then penetrates through a circumferential wall of the reactor containment vessel 1, and further extends within the reactor containment vessel 1.

The third branch pipe 14a is also slightly curved at a portion close to the reactor pressure vessel 2 so as to be along a circumferential wall of the reactor pressure vessel 2. Thereafter, the third branch pipe 14a changes its extending direction at angle of about 45 degrees when a piping layout is viewed from an upper position of a plane surface, whereby the third branch pipe 14a directs to the center portion of the reactor pressure vessel 2. As a result, the third branch pipe 14a is then straightly arranged along a normal line direction, and finally connected to the reactor pressure vessel 2.

Still furthermore, the third branch pipe 14a and a fourth branch pipe 14b are arranged in parallel with each other so as to extend in a direction perpendicular to the circumferential surface of the reactor containment vessel 1.

The fourth branch pipe 14b is also branched and connected to a portion close to a top end of the curved another main feedwater pipe 12b which goes around an outer circumference of the reactor containment vessel 1. The fourth branch pipe 14b is extended in a direction perpendicular to the third branch pipe 14a, and is directed to a center portion of the reactor pressure vessel 2. The direction of the fourth branch pipe 14b is perpendicular to that of the third branch pipe 14a, and is opposite to that of the first branch pipe 13a. As a result, the fourth branch pipe 14b is then straightly arranged along a normal line direction, and finally connected to the reactor pressure vessel 2.

Accordingly, only the first to fourth branch pipes 13a, 13b, 14a, 14b are provided within the reactor containment vessel 1, and the main feedwater pipes and the other feedwater pipes are not provided within the reactor containment vessel 1. That is, as a feedwater pipe penetrating through the circumferential wall of the reactor containment vessel 1, there exist only the first to fourth branch pipes 13a, 13b, 14a, 14b, so that the penetrating parts are limited to only four portions.

In this regard, the curved portions of the main feedwater pipe 12a, 12b that are arranged at the outer circumference of the reactor containment vessel 1 shown in FIG. 2 are not shown in FIG. 1, because the curved portions get behind the branch pipes in a thickness direction of a drawing sheet.

In this embodiment, as shown in FIG. 1 and FIG. 2, the boiling water reactor is provided with an emergency core cooling system (ECCS) for pouring the coolant supplied from the suppression chamber 3 into a reactor core and flooding the reactor core. That is, the emergency core cooling system (ECCS) comprises a reactor core isolation cooling system (RCIC) 15, a high pressure core flooder system (HPCF) 16, and a residual heat removal system (RHR) 17.

The reactor core isolation cooling system (RCIC) 15 comprises a reactor core isolation cooling system pump 15a, and a reactor core isolation cooling system injection pipe 15b. This reactor core isolation cooling system injection pipe 15b is connected to the first branch pipe 13a at the outside (connection point C) of the reactor containment vessel 1.

Further, the high pressure core flooder system (HPCF) 16 is configured so as to include independent two systems, and each of the systems comprises high pressure core flooder pumps 16a, 16b and high pressure core flooder injection pipes 21a, 21b. These high pressure core flooder injection pipes 21a, 21b are directly connected to the reactor pressure vessel 2.

The residual heat removal system (RHR) 17 is configured so as to include independent three systems, and each of the systems comprises residual heat removal system pumps 18a, 18b, 18c, residual heat removal system heat exchangers 22a, 22b, 22c, and residual heat removal system injection pipes 19a, 19b, 19c. Further, as shown in FIG. 2, the residual heat removal system injection pipes are connected to the first to fourth branch pipes, respectively (connection points D to F). In this connection, as shown in FIG. 1, the two lines of the high pressure core flooder injection pipes 21a, 21b are independently connected to the reactor pressure vessel 2.

Furthermore, as shown in FIGS. 1 and 2, each of the main feedwater pipes 12a, 12b is provided with various valves at the inside portion and the outside portion of the reactor containment vessel 1. That is, each of the main feedwater pipes 12a, 12b is subsequently provided with stop valves 30a, 30b for backup use, check valves 32a, 32b, and reactor containment vessel isolation valves 33a, 33b in this order from an upstream side to a downstream side at the outside portion of the reactor containment vessel 1.

Further, each of the main feedwater pipes 12a, 12b is provided with reactor containment vessel isolation valves 34a, 34b and stop valves 35a, 35b for maintenance check in this order from an upstream side to a downstream side at the inside portion of the reactor containment vessel 1.

Among these valves, the reactor containment vessel isolation valves 33a, 33b, 34a, 34b are arranged into the main feedwater pipes 12a, 12b at the inside and outside portions of the reactor containment vessel 1 so that the reactor containment vessel isolation valves 33a, 33b, 34a, 34b are confronted to each other at border portions where the main feedwater pipes 12a, 12b penetrate through the reactor containment vessel 1.

Further, in the outside of the reactor containment vessel 1, the reactor core isolation cooling system injection pipe 15b is connected to the main feedwater pipe 12a, while the residual heat removal system injection pipe 19b is connected to another main feedwater pipe 12b.

The reactor core isolation cooling system injection pipe 15b and the residual heat removal system injection pipe 19b are provided with stop valves 36a, 36b for backup use and check valves 37a, 37b in this order from an upstream side to a downstream side.

Furthermore, at the outside of the reactor containment vessel 1, the residual heat removal system injection pipes 19a, 19b, 19c are provided with stop valves 38a, 36b, 38b for backup use and reactor containment vessel isolation valves 38a, 37a, 38b in this order from an upstream side to a downstream side.

On the other hand, at the inside of the reactor containment vessel 1, the residual heat removal system injection pipes 19a, 19b, 19c are provided with reactor containment vessel isolation valves 40a, 34b, 40b and stop valves 41a, 35a, 41b for maintenance check in this order from an upstream side to a downstream side.

As described above, in this embodiment, the reactor feedwater system has a structure in which the main feedwater pipe is provided to the outside of the reactor containment vessel, and branching positions at which the branch pipes are branched from the main feedwater pipe are set to the outside of the reactor containment vessel, and only the branch pipes penetrate through the reactor containment vessel and are connected to the reactor pressure vessel 2. In addition, each of the branch pipes is provided with the reactor containment vessel isolation valves.

Further, the reactor containment vessel isolation valves are provided to each of the branch pipes at the inside position and the outside position of the reactor containment vessel 1 so as to form a paired isolation valves. An injection pipe of either the reactor core isolation cooling system or the residual heat removal system of the emergency core cooling system is connected to a portion between the paired reactor containment vessel isolation valves, respectively.

The emergency core cooling system includes one system of the reactor core isolation cooling system and independent three systems of the residual heat removal system. The injection pipes of the reactor core isolation cooling system and the residual heat removal system are connected to the respective branch pipes.

In this embodiment of the structure mentioned above, when a rapture of the main feedwater pipe occurs, the rapture portion and the reactor pressure vessel 2 are isolated by the reactor containment vessel isolation valves. Therefore, the rapture of the main feedwater pipe would not be led to a loss of coolant accident. As an assumption required for coping with this type of accident, it is sufficient to assume only a rapture of the branch pipes. As a result, even if the rapture of the branch pipe occurs, it becomes possible to reduce by half an amount of coolant which is generated from the reactor pressure vessel 2 and discharged into the reactor containment vessel 1.

Further, all of three lines of injection pipes 19 of the residual heat removal system (RHR) 17 are connected to the branch pipes, so that it becomes unnecessary to form a penetrating portion of the reactor containment vessel, a piping in the reactor containment vessel, a connection nozzle for connecting the injection pipe to the reactor pressure vessel 2, and a water-pouring internal structure in the reactor pressure vessel 2, as essential elements for exclusive use.

In addition, according to the reactor feedwater system of the present embodiment, there is no need to provide the main feedwater pipe and the injection pipes of the residual heat removal system in the reactor containment vessel, and a free space volume required for the reactor containment vessel at a time of the loss of coolant accident can be effectively reduced, so that the reactor containment vessel can be remarkably downscaled.

Further, since the branch pipe has a pipe diameter larger than that of an injection pipe of the residual heat removal system, a fluid resistance in the branch pipe can be lowered, thus enabling the residual heat removal system pump to decrease a required pump head (load lifting height) thereof. According to this structure, a required driving power of the residual heat removal system pump can be also reduced. Accordingly, there can be also reduced a capacity of an emergency power source (backup power source) for supplying an electrical power to the residual heat removal system pump at the time of the loss of coolant accident or the like.

Although the present embodiment has been explained by taking up a case where two lines of branch pipes are branched from the respective main feedwater pipes, the same functions and effects as those in the case of the two lines of branch pipes are obtainable in a case where three lines of branch pipes are branched from the respective main feedwater pipes, except that the amount of coolant, which is generated from the reactor pressure vessel 2 and discharged into the reactor containment vessel 1 at the time of rapture of the branch pipe, is reduced to be ⅓.

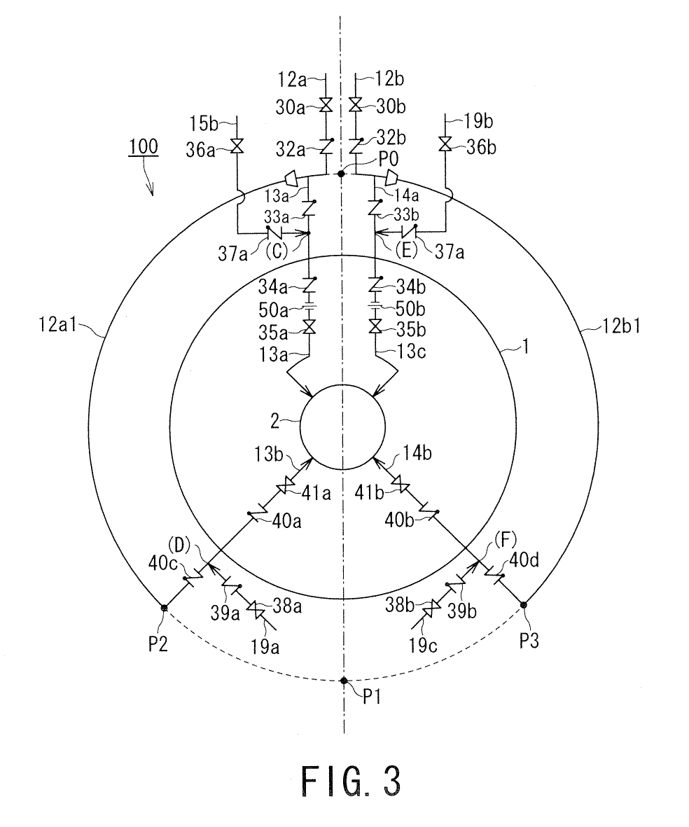

FIG. 3 shows another embodiment of the reactor feedwater system 100 according to the present invention.

In the embodiment shown in FIG. 3, the following features are attained in addition to those of the previous embodiment. That is, flow restriction mechanisms 50a, 50b is provided on a halfway of branch pipes 13a, 14a that are located and branched at a most upstream side in the coolant supplying direction, while a diameter of the main feedwater pipes 12a1, 12b1 that are located at downstream side from a branching position of the branch pipes is set to be smaller than that of the main feedwater pipes 12a, 12b that are located at upstream side from the branching position. As a result, the diameter of the main feedwater pipe of the downstream side is set to the same as that of the branch pipe.

The flow restriction mechanism may be configured by using a restriction orifice or a flow nozzle. The arrangements of elements or parts of this embodiment are substantially the same as those of the previous embodiment. Therefore, with respect to the same elements or parts as those already explained in embodiment shown in FIG. 2, detailed explanation thereof will be omitted herein only by adding the same reference numerals shown in FIG. 2 into FIG. 3.

In this embodiment configured as above, a resistance coefficient of the flow restriction mechanism is given so as to be equal to a resistance coefficient of the main feedwater pipe ranged from a branching position of the branch pipe disposed at most upstream side to an inlet portion of the branch pipe disposed at downstream side. As a result, flow rates of the feedwater flowing in both the branch pipe at upstream side and downstream side are equal to each other.

According to the present embodiment, the diameter of the main feedwater pipe arranged so as to surround the outer circumference of the reactor containment vessel can be reduced to be small, so that the main feedwater pipe can be arranged more easily.

By the way, in the present embodiment, the flow restriction mechanism is disposed between the reactor containment vessel isolation valve and a stop valve for maintenance check provided in the reactor containment vessel. However, the present invention is not limited thereto, and the flow restriction mechanism may be also disposed to the other portion in the branch pipe.

As mentioned, it is to be noted that the present invention is not limited to the described embodiments and many other changes and modifications may be made without departing from the scopes of the appended claims.

What is claimed is:

1. A reactor feedwater system of a boiling water reactor comprising:
a reactor feedwater pump and a high pressure feedwater heater, that are arranged at an outside of a reactor containment vessel containing a reactor pressure vessel of a boiling water reactor, for pressurizing and heating a coolant;
a main feedwater pipe for supplying the coolant, that are pressurized and heated by the reactor feedwater pump and the high pressure feedwater heater, to a side of the reactor containment vessel; and
a plurality of branch pipes, that are connected to the main feedwater pipe, for pouring the coolant into the reactor pressure vessel,
wherein the main feedwater pipe is provided to the outside of the reactor containment vessel, and branching positions at which the branch pipes are branched from the main feedwater pipe are set to the outside of the reactor containment vessel, so that only the branch pipes penetrate through the reactor containment vessel and are connected to the reactor pressure vessel.

2. The reactor feedwater system according to claim 1, wherein each of the branch pipes is provided with a reactor containment vessel isolation valve.

3. The reactor feedwater system according to claim 2, wherein the containment vessel isolation valve is provided to both inner and outer positions of the reactor containment vessel in a paired manner, and an injection pipe of either a reactor core isolation cooling system or a residual heat removal system of an emergency core cooling system is connected to a portion between the paired containment vessel isolation valves.

4. The reactor feedwater system according to claim 3, wherein the emergency core cooling system includes one series of the reactor core isolation cooling system, and independent three series of the residual heat removal systems, and the injection pipes of these reactor core isolation cooling system and independent three series of the residual heat removal systems are connected to the branch pipes, respectively.

5. The reactor feedwater system according to claim 1, wherein the respective branch pipes are branched from the main feedwater pipe at a plurality of branching positions, a flow restriction mechanism is provided to a halfway of a branch pipe which is located and branched at a most upstream side in the coolant supplying direction, and a diameter of the main feedwater pipe, which is located at downstream side from a branching position of the branch pipe, is set to be smaller than that of a main feedwater pipe which is located at upstream side from the branching position.

6. The reactor feedwater system according to claim 5, wherein the flow restriction mechanism is composed of a restriction orifice.

7. The reactor feedwater system according to claim 5, wherein the flow restriction mechanism is composed of a flow nozzle.
